(19) United States
(12) Patent Application Publication
(10) Pub. No.: US 2007/0065703 A1
(43) Pub. Date: Mar. 22, 2007

(54) Durable conductive adhesive bonds for fuel cell separator plates

(76) Inventors: Mahmoud H. Abd Elhamid, Grosse Pointe Woods, MI (US); John N. Owens, Franklin, MI (US); Daniel J. Lisi, Eastpointe, MI (US); Richard H. Blunk, Macomb Township, MI (US); Youssef M. Mikhail, Sterling Heights, MI (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/229,822

(22) Filed: Sep. 19, 2005

(51) Int. Cl. H01M 8/02; B32B 19/00; C09J 163/00

(52) U.S. Cl. 429/34; 156/330; 428/688; 429/38

(57) ABSTRACT

The present invention relates to an electrically conductive element, such as a bipolar plate, for a fuel cell which has an improved adhesive bond. The conductive element generally comprises a first and a second conductive sheet, each having a surface that confronts one another. The first and said second coated surfaces are joined to one another by an electrically conductive epoxy adhesive which provides adhesion of the first and said second surfaces of the sheets at one or more contact regions.

### FIELD OF THE INVENTION

The present invention relates to PEM fuel cells and, more particularly, to electrically conductive separator plates and methods for making the same.

### BACKGROUND OF THE INVENTION

Fuel cells have been proposed as a power source for electric vehicles and other applications. One known fuel cell is the proton exchange membrane (PEM) fuel cell that includes a so-called membrane-electrode-assembly (MEA) comprising a thin, solid polymer membrane-electrolyte having an anode on one face and a cathode on an opposite face of the membrane.

The MEA is sandwiched between a pair of electrically conductive contact elements which serve as current collectors for the anode and cathode. The current collectors may contain appropriate channels and openings therein for distributing the fuel cell's gaseous reactants (i.e., H₂ & O₂/air) over the surfaces of the respective anode and cathode.

Where a plurality of MEAs is stacked together in electrical series, they are separated one from the next by an impermeable, electrically conductive contact element known as a bipolar or separator plate. The separator or bipolar plate has two working faces, one confronting the anode of one cell and the other confronting the cathode on the next adjacent cell in the stack. Each bipolar plate electrically conducts current between the adjacent cells. Contact elements at the ends of the stack are referred to as end, terminal, or collector plates. The conductive separator elements often have internal passages through which coolant flows to remove heat from the stack.

Bipolar plates are generally fabricated from two separate conductive sheets that must be joined together at one or more joints. The joints must withstand the harsh conditions of the fuel cell. The bipolar plates must provide high electrical conductivity to reduce voltage losses, have a low weight to improve gravimetric efficiency, and exhibit durability for long-term operational efficiency. There remains the challenge to optimize the bonding of the individual components of the electrically conductive separator elements in a fuel cell to promote efficiency as cost-effectively as possible.

### SUMMARY OF THE INVENTION

In one embodiment, the present invention relates to a conductive element for a fuel cell comprising a first conductive sheet having a first surface and a second conductive sheet having a second surface. The first surface confronts the second surface. A conductive adhesive is disposed between and in contact with the first surface and the second surface at one or more contact regions. The adhesive forms a durable bond between the first and second surfaces. The bond has an electrical resistance of less than or equal to about 5 mΩ.cm² under a compressive force of greater than or equal to about 1000 kPa. In certain embodiments, the electrical resistance is less than or equal to about 4 mΩ.cm² or less under the same conditions. Further, the conductive adhesive preferably comprises an epoxy resin precursor. In certain preferred embodiments, the epoxy adhesive is a polyepoxide polymer cured with a diamine, thus a reaction product formed from a two-part epoxy adhesive system. In one embodiment, the epoxy adhesive is formed from a bisphenol A diepoxide resin. The adhesive further comprises a plurality of conductive particles, where the conductive particles preferably include graphite and carbon black.

In other embodiments of the present invention, a method of forming a durable electrical conductive contact element for a PEM fuel cell is provided. The method comprises a two-component epoxy adhesive system with a plurality of conductive particles comprising graphite and carbon black. The two-component epoxy adhesive system is applied to at least one of: a first conductive sheet of the element having a first surface and a second conductive sheet of the element having a second surface. The first surface is contacted with the second surface, where the applied adhesive system is disposed between and in contact with the first surface and the second surface at one or more contact regions. The adhesive polymer system is cured to create an electrically conductive, durable bond at the one or more contact regions between the first and second surfaces.

In yet other embodiments of the present invention, a fuel cell stack comprises a plurality of fuel cells and an electrically conductive element sandwiched between an anode and cathode of adjacent fuel cells. The stack comprises a first electrically conductive sheet having an anode confronting surface and a first heat exchange surface and a second electrically conductive sheet having a cathode confronting surface and a second heat exchange surface. The first and second heat exchange surfaces confront each other so as to define therebetween a coolant flow passage adapted to receive a liquid coolant and are electrically coupled to one another at a plurality of contact regions via an electrically conductive adhesive comprising a plurality of conductive particles dispersed in a cured epoxy polymer having adhesive properties. The electrically conductive adhesive defines an electrically conductive path between the first and second sheets.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of two cells in a liquid-cooled PEM fuel cell stack;

FIG. 2 is an exemplary electrically conductive separator element showing one preferred embodiment of the present invention;

FIG. 3 is a cross-sectional view taken along line 3-3 of FIG. 2, showing a conductive element of a preferred embodiment of the present invention;

FIG. 4 is a magnified view of a contact region shown in FIG. 3;

FIG. 5 is a magnified view of an alternate embodiment of a contact region of the present invention, where an intermediate separator plate is disposed between a first and a second sheet of the conductive element; and

FIG. 6 is an exemplary testing apparatus used to measure the contact resistance of a sample.

### DETAILED DESCRIPTION OF THE PREFERRED EMBODIMENTS

The following description of the preferred embodiment(s) is merely exemplary in nature and is in no way intended to limit the invention, its application, or uses. The present invention contemplates an electrically conductive element (e.g., a bipolar plate) for a fuel cell which has an improved adhesive bond. The conductive element generally comprises a first and a second conductive sheet; each has a surface that confronts one another. The surfaces that confront one another are adhered to one another at one or more contact regions by a conductive adhesive that provides a strong, durable bond having a low contact resistance that is desirable for use in a fuel cell. Further, the present invention contemplates methods to form such an improved bond in an electrically conductive element.

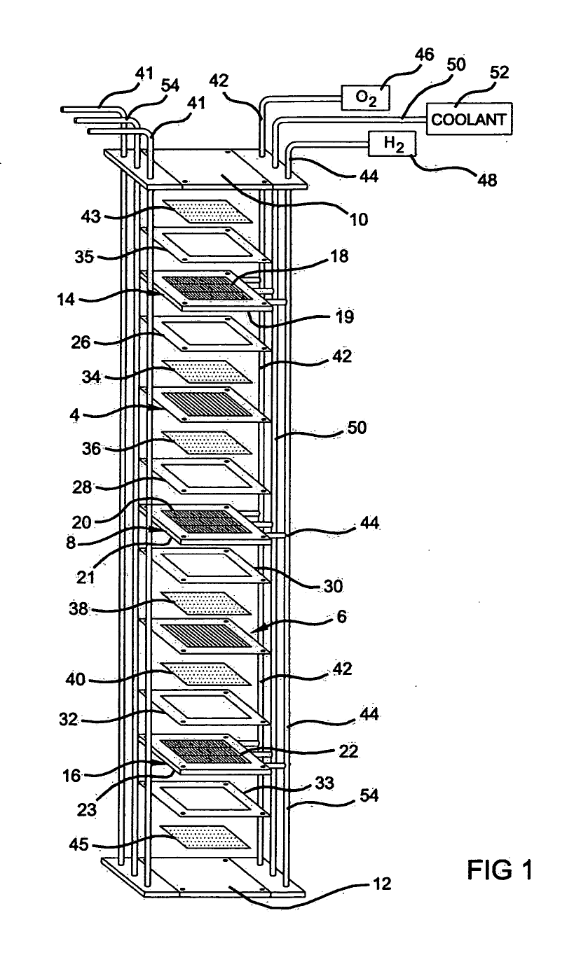

First, to better understand the present invention, a description of an exemplary fuel cell and stack are provided. FIG. 1 depicts two individual proton exchange membrane (PEM) fuel cells connected to form a stack having a pair of membrane-electrode-assemblies (MEAs) 4, 6 separated from each other by an electrically conductive, liquid-cooled, bipolar separator plate conductive element 8. An individual fuel cell that is not connected in series within a stack has a separator plate 8 with a single electrically active side. In a stack, a preferred bipolar separator plate 8 typically has two electrically active sides 20, 21 within the stack, each active side 20, 21 respectively facing a separate MEA 4, 6 with opposite charges that are separated, hence the so-called “bipolar” plate. As described herein, the fuel cell stack is described as having conductive bipolar plates; however the present invention is equally applicable to a single fuel cell.

The MEAs 4,6 and bipolar plate 8 are stacked together between stainless steel clamping terminal plates 10,12 and end contact fluid distribution elements 14,16. The end fluid distribution elements 14, 16, as well as both working faces or sides 20,21 of the bipolar plate 8, contain a plurality of lands adjacent to grooves or channels on the active faces 18, 19, 20, 21, 22, and 23 for distributing fuel and oxidant gases (i.e., H₂ and O₂) to the MEAs 4,6. Nonconductive gaskets or seals 26, 28, 30, 32, 33, and 35 provide seals and electrical insulation between the several components of the fuel cell stack. Gas-permeable conductive diffusion media 34, 36, 38, and 40 press up against the electrode faces of the MEAs 4, 6. Additional layers of conductive media 43, 45 are placed between the end contact fluid distribution elements 14, 16 and the terminal collector plates 10, 12 to provide a conductive pathway therebetween when the stack is compressed during normal operating conditions. The end contact fluid distribution elements 14, 16 press up against the diffusion media 34, 43 and 40, 45 respectively.

Oxygen is supplied to the cathode side of the fuel cell stack from storage tank 46 via appropriate supply plumbing 42, while hydrogen is supplied to the anode side of the fuel cell from storage tank 48, via appropriate supply plumbing 44. Alternatively, air may be supplied to the cathode side from the ambient, and hydrogen to the anode from a methanol or gasoline reformer, or the like. Exhaust plumbing 41 for both the H₂ and O₂/air sides of the MEAs is also provided. Additional plumbing 50 is provided for circulating coolant from a storage area 52 through the bipolar plate 8 and end plates 14, 16 and out the exit plumbing 54.

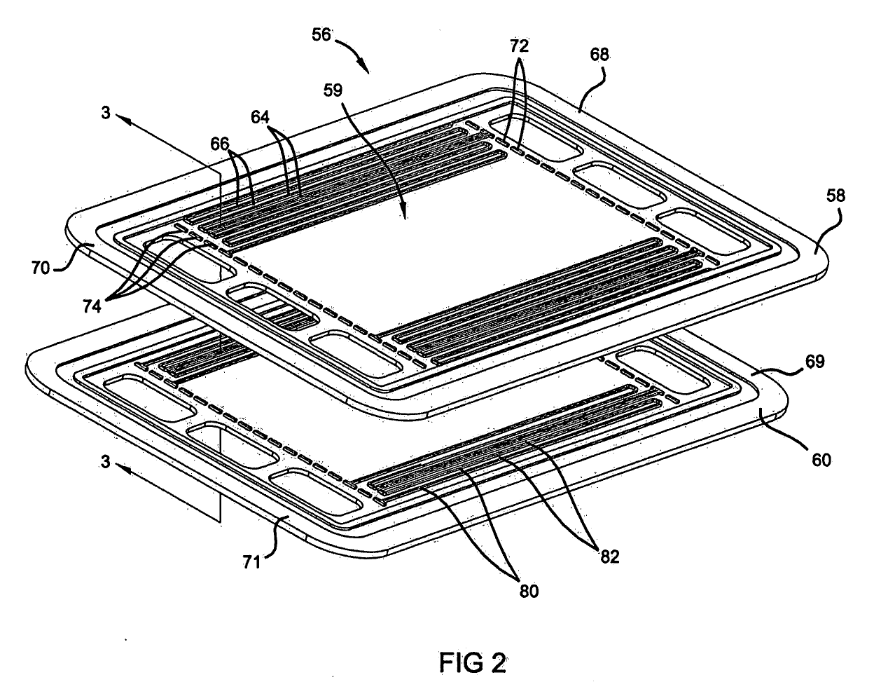

The present invention relates to conductive elements in a fuel cell, such as the liquid-cooled, bipolar separator plate 56 shown in FIG. 2, which separates adjacent cells of a PEM fuel cell stack, conducts electric current between adjacent cells of the stack, and cools the stack. The separator bipolar plate 56 comprises a first exterior sheet 58 and a second exterior sheet 60. The sheets 58,60 may be formed from a metal, a metal alloy, or a composite material, and are preferably electrically conductive. Suitable metals, metal alloys, and composite materials have sufficient durability and rigidity to function as sheets in a conductive element within a fuel cell. Additional design properties for consideration in selecting a material for the plate body include gas permeability, conductivity, density, thermal conductivity, corrosion resistance, pattern definition, thermal and pattern stability, machinability, cost and availability. Available metals and alloys include titanium, platinum, stainless steel, nickel based alloys, and combinations thereof. Composite materials may comprise graphite, graphite foil, conductive particles (e.g., graphite powders) in a polymer matrix, carbon fiber paper and polymer laminates, polymer plates with metal cores, conductively coated polymer plates, and combinations thereof.

In certain embodiments, the individual sheets 58,60 may be made as thin as possible (e.g., about 0.002-0.02 inches or 0.05-0.5 mm thick). The sheets 58,60 may be formed by any method known in the art, including machining, molding, cutting, carving, stamping, photo etching such as through a photolithographic mask, or any other suitable design and manufacturing process. It is contemplated that the sheets 102, 104 may comprise a laminate structure including a flat sheet and an additional sheet including a series of exterior fluid flow channels.

The external sheet 58 has a first working surface 59 on the outside thereof which confronts an anode of an MEA (not shown) and is formed so as to provide a plurality of lands 64 which define therebetween a plurality of grooves 66 known as a “flow field” through which the fuel cell's reactant gases (i.e., H₂ or O₂) flow in a tortuous path from one side 68 of the bipolar plate to the other side 70 thereof. When the fuel cell is fully assembled, the lands 64 press against the carbon/graphite papers (such as 36 or 38 in FIG. 1) which, in turn, press against the MEAs (such as 4 or 6 in FIG. 1, respectively). For drafting simplicity, FIG. 2 depicts only two arrays of lands 64 and grooves 66. In reality, the lands and grooves 64,66 will cover the entire external surfaces of the sheets 58, 60 that engage the carbon/graphite diffusion media. The reactant gas is supplied to grooves 66 from a header or manifold groove 72 that lies along one side 68 of the fuel cell, and exits the grooves 66 via another header/manifold groove 74 that lies adjacent the opposite side 70 of the fuel cell.

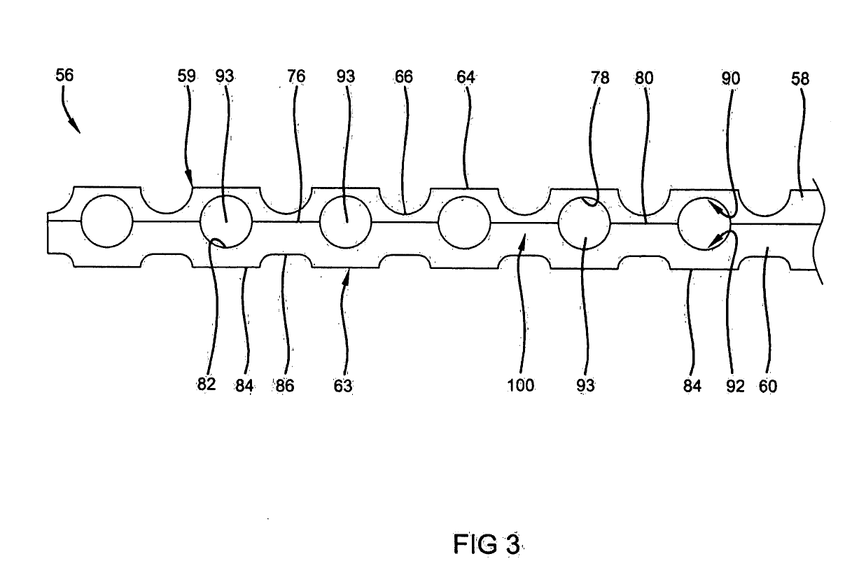

As best shown in FIG. 3, the underside of the sheet 58 includes a plurality of ridges 76 which define therebetween a plurality of channels 78 through which coolant passes during the operation of the fuel cell. As shown in FIG. 3, a coolant channel 78 underlies each land 64 while a reactant gas groove 66 overlies each ridge 76. Alternatively, the sheet 58 could be flat and the flow field formed in a separate sheet of material. Sheet 60 is similar to sheet 58. In this regard, there is depicted a plurality of ridges 80 defining therebetween a plurality of channels 82 through which coolant flows from one side 69 of the bipolar plate to the other 71. The heat exchange (coolant side) surfaces 90,92 of the first and second sheets 58,60 confront each other so as to define therebetween the coolant flow passages 93 adapted to receive a liquid coolant, and are electrically coupled to each other at a plurality of joints, or contact regions 100. Like sheet 58 and as best shown in FIG. 3, the external side of the sheet 60 has a working surface 63 facing a cathode of another MEA having a plurality of lands 84 thereon defining a plurality of grooves 86 through which the reactant gases pass.

Coolant flows between the channels 93 formed by sheets 58,60 respectively, thereby breaking laminar boundary layers and affording turbulence which enhances heat exchange with inside surfaces 90, 92 of the exterior sheets 58, 60 respectively. As recognized by one of skill in the art, the current collectors of the present invention may vary in design from those described above, such as for example, in the configuration of flow fields, placement and number of fluid delivery manifolds, and the coolant circulation system, however, the function of conductance of electrical current through the surface and body of the current collector functions similarly between all designs. In preferred embodiments of the present invention, an electrically conductive path of good durability is formed across the contact regions 100. In circumstances where the electrical resistance across the contact regions 100 is too high, a significant amount of heat is generated at the contact regions 100, which is transferred to the coolant. It is preferred that the sustainable electrical resistance across the conductive path is low enough that it does not cause overheating of the coolant. Moreover, high electrical resistance across the conductive path results in voltage (power) losses in the stack.

Thus in accordance with the present invention, overheating of the MEA coolant is prevented or its occurrence is at least reduced, since the thermal conductivity of the bond is high and tends to be correlated to a high electrical conductivity of the bond. By the present invention, stack power loss resulting from excessive electrical voltage drop across the bond is ameliorated. Stack voltage loss due to bondline resistance is preferably less than or equal to 10% of the power generated by the stack, desirably 5% or less, and still more preferably on the order of 1% or less. The contact region 100 is often referred to as the “bond” or “bondline”. In accordance with various embodiments of the present invention, degradation of the bondline is lessened and/or prevented.

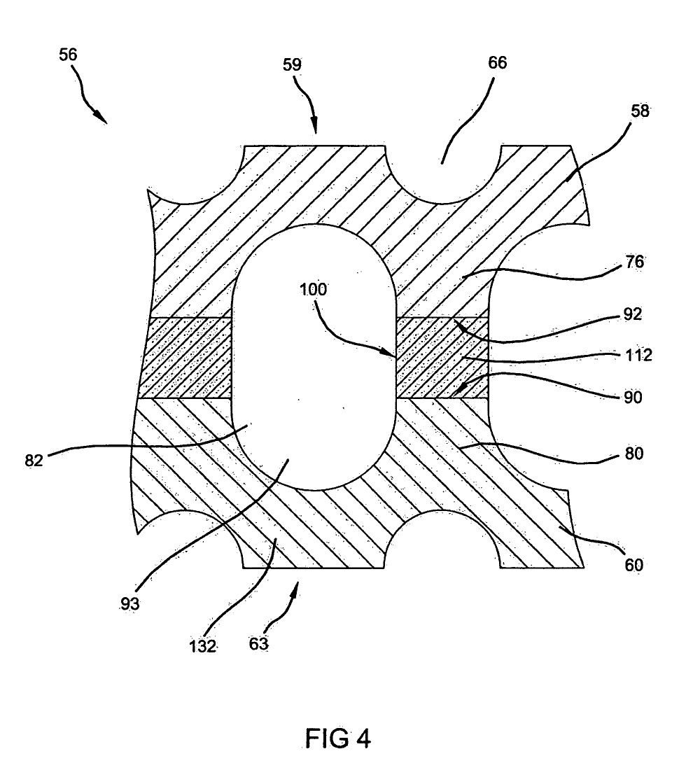

FIG. 4 is a magnified view of a portion of FIG. 3 and shows the ridges 76 on the first sheet 58 and the ridges 80 on the second sheet 60 are coupled to one another in the contact region 100 to ensure the structural integrity of the separator element 56. The first sheet 58 is joined at the contact region 100 directly (i.e., without an intermediate spacer sheet) to the second sheet 60 via a plurality of conductive joints in discrete contact regions 100. The contact region 100 provides an electrically conductive path that is required for the bipolar plate element to function as a current collector.

In accordance with various embodiments of the present invention, the adhesive bond at the contact region 100 is robust and durable within harsh operating conditions of a fuel cell. For example, the adhesive of the present invention may have a thermal coefficient that is similar to the materials forming the elements 58,60 that minimizes bondline degradation as the fuel cell cycles through temperature variations associated with normal operation. Further, the present invention minimizes the amount of conductive particles needed to impart the desired conductivity across the bond, enhancing the adhesiveness of the bond. Thus, the present invention minimizes bondline degradation and maintains a low contact (bondline) resistance across the contact region 100, to maintain permissible levels even after long-term operation (i.e., greater than 500 operational hours).

Typical conditions in a fuel cell include a compressive load of about 200 psi (about 1400 kPa) at 80° C. and 100% relative humidity, so that the compressive force compensates for general “debonding” or adhesive bond degradation at the contact regions 100. Thus, flaws in the bond integrity generally appear after longer durations of operation and the overall long-term bond stability degrades, such as for example from between 500 hours of operation to 6000 hours of fuel cell operation. Thus, any issues with the durability of a bond may not become apparent until after 500 hours of operation, and in some cases until after 6000 hours of operation.

Various embodiments of the present invention provide a durable bond having high electrical conductivity that minimizes material requirements and processing steps, as compared to conventional methods of bonding plates to one another (for example, with the use of primer coatings and adhesives and high conductive particle loading). In accordance with the present invention, a low-resistance bond can be achieved for the separator plates, with simplified material requirements while maintaining durability and long-life.

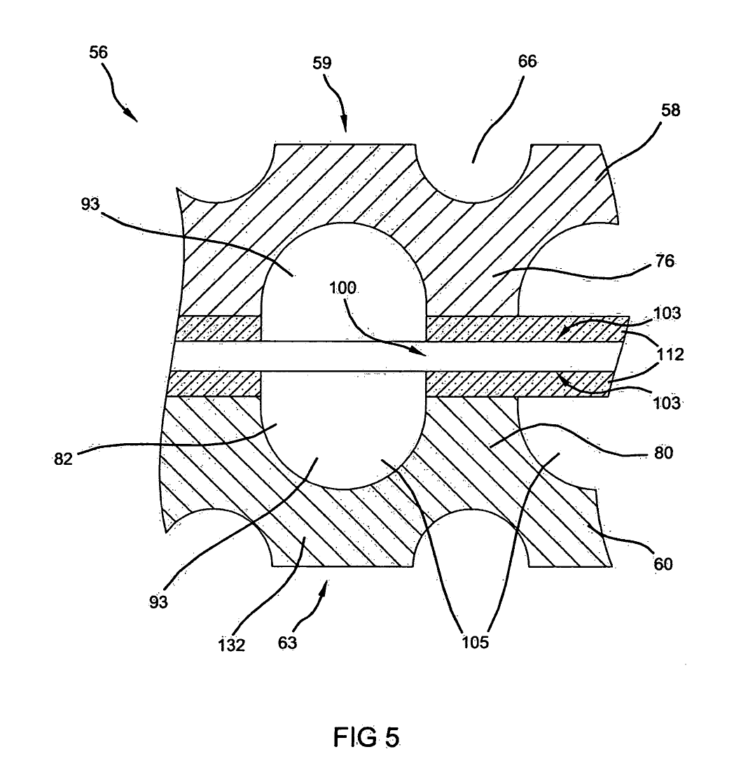

The present invention is also applicable to any electrically conductive elements that are joined to one another within the fuel cell. While the first and second sheets 58,60 may be adhered directly to each other in accordance with the present invention as shown in FIG. 4, in a bi-polar plate assembly 56, the first and second sheets 58,60 may alternatively be glued to a discrete intermediate, separator conductive sheet 101 (FIG. 5) that may partition the coolant flow passage 93. The intermediate separator sheet 101 may be perforated so as to permit coolant to move between the smaller coolant flow passages 93. In such an embodiment, the separator sheet 101 will be treated in accordance with the present invention by adhering the contact surfaces 103 of the separator sheet 101 to the respective first and second conductive sheets 58,60. The separator sheet 101 may be corrugated to provide a plurality of coolant channels 105 in the coolant flow passage 93, or may be a flat sheet joined to first and second outer sheets which each have a plurality of coolant flow channels formed therein, as for example by corrugating the outer sheets.

All mutually contacting regions 100 of the exterior sheets 58,60 (and interior separator sheet when used) are adhered together to insure that the coolant passage 93 is sealed, preferably in a sustained sealing engagement that is fluid tight against coolant leakage and to provide low resistance electrical conduction between adjacent cells. A sustained sealing engagement is one that preferably lasts greater than 500 operational hours, and preferably greater than 6000 operational hours upon exposure to fuel cell operating conditions. A fluid tight seal is a seal formed at the contact regions 100 that prevents, or at least impedes, fluid and gas transport therethrough. The electrically conductive adhesive also serves as a conductive filler for filling any gaps between the sheets 58, 60 resulting from irregularities in the sheets. The present invention is also applicable to the terminal conductive elements (e.g. 14, 16 of FIG. 1) at the ends of the stack that provide cooling and current collection.

The present invention provides a conductive element within a fuel cell where the respective surfaces 90,92 of the first sheet 58 and the second sheet 60 will confront one another at one or more contact regions 100, as shown in FIG. 4. An electrically conductive adhesive 112 is disposed between the first and second surfaces 90,92, such that the bond formed at the contact region 100 has enhanced long-term durability and sustainable contact (bondline) resistance beyond 500 hours of operation. As part of the present invention, it is preferred that all metal oxides are removed from the surfaces 90,92 of where sheets 58,60 are metal, especially in the contact regions 100, to create as low resistance electrical connection as is possible between the sheets 58,60 through the adhesive 112 of the bondline. Nonmetallic sheets (e.g., polymeric composites or graphite) do not require oxide removal, but may require sanding or removal of the insulating polymer-rich film at the sheet surface formed during molding.

In accordance with the present invention, the quantity of conductive particles that are necessary in the adhesive 112 is significantly reduced from comparative electrically conductive adhesives. In certain embodiments, the conductive particles are selected to have very high electrical (and desirably thermal) conductivity, consequently having low electrical resistivity. Further, by inclusion of highly conductive particles, the amount of particles required to maintain electrical conductivity through the contact regions is significantly reduced from traditional conductive adhesives. This aspect of the present invention permits higher quantities of the adhesive resin to be included, improving the tackiness and adherent properties of the adhesive. While not limiting the present invention to any theory, it appears that much higher quantities of adhesive maintain a durable and robust bond. This is particularly true where the adhesive comprises epoxy.

In various embodiments of the present invention, the conductive adhesive 112 comprises a cured polymer resin matrix and conductive particles. In the adhesive 112, it is preferred that the conductive particles are less than or equal to about 30% by weight of the adhesive, more preferably less than or equal to about 20% by weight of the adhesive, even more preferably less than or equal to about 10% by weight, and in certain embodiments less than or equal to about 5% by weight of the adhesive, depending on the relative conductivity of the respective conductive particles selected.

In preferred embodiments of the present invention, the conductive particles comprise graphite and carbon black that are mixed with an adhesive that is formed from an epoxy, where the conductive particles are represented in amounts yielding a desired total carbon content of the adhesive. In preferred embodiments, the total carbon is less than or equal to 25% by weight, and more specifically less than or equal to about 10% by weight total carbon. One example of a coating composition employing graphite and carbon mixed with a polymer can be found in U.S. Patent Publication No. 2004/0091768 to Abd Elhamid, et al. that is herein incorporated by reference in its entirety.

In certain embodiments, the adhesive 112 comprises graphite and carbon black at a ratio ranging from about 1:6 to about 35:1 by weight. In one particularly preferred embodiment, the ratio of graphite to carbon is about 2:1 on a weight basis. Referring specifically to the amount of graphite in the adhesive 112, in one embodiment, the adhesive may comprise between about 3.0% by weight and about 50%, by weight, graphite. Referring specifically to the amount of carbon black in the adhesive 112, the adhesive may comprise between about 1.5% by weight and about 20%, by weight, carbon black.

Various types of graphite are particularly preferred for use in the adhesive 112. The graphite may be selected from expanded graphite, graphite powder, graphite flakes, and combinations of these. The graphite may be characterized by a particle size (measured in the longest dimension) between about 5 μm and about 90 μm. The graphite may have a low bulk density, which is generally less than 1.6 g/cm³, and more specifically, less than about 0.3 g/cm³. The intrinsic density may range between about 1.4 g/cm³ and about 2.2 g/cm³. The graphite may have a relatively high purity and being substantially free of contaminants. Expanded graphite having any of the above described features for use in an adhesive 112 according to the present invention may be produced by any suitable method. In one embodiment a suitable graphite material that may be used is available from Sigri Great Lakes of Charlotte, N.C. under the tradename SIGRIFLEX.

Additionally, various types of carbon black are suitable for use in the adhesive. By way of illustration and not by limitation, the carbon black may be selected from acetylene black, KETJEN™ black, Vulcan black, REGAL™, furnace black, black pearl and combinations thereof. Carbon black may be characterized by a particle size between about 0.05 and about 0.2 μm. The carbon black preferably contains few impurities.

In accordance with a preferred embodiment of the present invention the conductive adhesive 112 comprises about 5% to about 30% percent by weight of carbon and graphite conductive particles with a particle size varying between about 10 microns to about 50 microns. It is preferred that the electrical contact resistance of the adhesive 112 is maintained below about 15 mΩ.cm², while minimizing the actual quantity of particles to maximize the adhesiveness of the composition.

In addition to the differing amounts of graphite and carbon black, the adhesive 112 may also include differing amounts of adhesive polymer matrix. The amount of adhesive polymer may vary depending upon the amount of conductive particles used in the adhesive composition 112. Generally, higher polymer content is desired for enhanced adhesion, corrosion resistance, and application flow. In one embodiment, the adhesive 112 comprises between about 1% and 95% by weight of polymer matrix, more preferably greater than or equal to about 70% by weight, even more preferably 80% by weight. In some embodiments, the adhesive polymer is present at greater than or equal to about 90% by weight of the adhesive 112. In certain embodiments, the adhesive 112 comprises about 90 to about 95% of adhesive polymer. In preferred embodiments, the polymer of the adhesive 112 comprises an epoxy adhesive.

A variety of different adhesive compositions for use as the matrix polymer of the adhesive 112 are contemplated by the present invention. In one embodiment, the adhesive 112 is in the form of a gel. Specifically, in one preferred embodiment, the coating comprises about 6.7% by weight of expanded graphite, having a particle size from about 5 μm to about 90 μm, about 3.3% by weight of acetylene black, having a particle size of about 0.05 μm to about 0.2 μm, and about 90% by weight of epoxy polymer.

Furthermore, in certain embodiments, the adhesive 112 can be manufactured such that it comprises less than 200 ppm of metal contaminants. In one embodiment, plates bonded with the adhesive 112 exhibit a total resistance from about 5 to about 60 mΩ.cm² (milli-Ohms square centimeter) at a contact pressure of between 25 and about 200 psi (170 to 1400 kPa). Total resistance indicates the resistance across the entire assembly 56 from a first surface 59 to a second surface 63, including the bulk and contact resistance of the material of each separator plate sheet 58,60 as well as the bondline resistance through the contact region 100. The bondline resistance across the adhesive bond 112 at the one or more contact regions 100 is preferably less than about 5 mΩ.cm².

In various embodiments of the present invention, the adhesive 112 bond has a resistance of less than or equal to about 5 mΩ.cm², preferably less than or equal to about 5 mΩ.cm², more preferably less than or equal to about 4 mΩ.cm², in certain embodiments more preferably less than or equal to about 3 mΩ.cm², in yet other embodiments, less than or equal to about 2 mΩ.cm² and in certain embodiments, less than about 1 mΩ.cm², where the bond is under a compressive force of greater than or equal to about 150 psi (about 1000 kPa), particularly after operating in a fuel cell in excess of 500 hours, and more preferably after 1400 hours.

In certain embodiments, the bond resistance is less than or equal to about 4 mΩ.cm² under a compressive force of greater than or equal to about 1400 kPa after exposure to fuel cell operating conditions in excess of 500 hours. In yet other embodiments, the bond resistance is less than or equal to about 1 mΩ.cm² under a compressive force of greater than or equal to about 1400 kPa after exposure to fuel cell operating conditions in excess of 500 hours.

In preferred embodiments where graphite and carbon black are selected as the conductive particles in the adhesive 112, a synergism has been found to exist between the expanded graphite and carbon black. The contact resistance of the adhesive bond preferably remains low at less than 5 mΩ.cm² with low total carbon content. The “synergism” refers to the combination of graphite and carbon black producing a lower contact resistance than when either the graphite or the carbon black are used alone at the same total carbon content. In certain embodiments, such a synergism is greater than mere additive effects of the carbon black and expanded graphite alone. Thus, in preferred embodiments, the adhesive matrix 112 comprises both graphite and carbon black; however other combinations of conductive particles with binder in the adhesive matrix 112 that exhibit a relatively low resistance are also suitable and contemplated for the present invention.

The conductive adhesive 112 may be prepared to overlay or coat the contact regions 100 of the surfaces 90, 92 of the electrically conductive elements 58, 60 by conventional means known of one of skill in the art. An example of such preparation includes milling the conductive particles and the uncured epoxy resin polymer matrix (i.e., adhesive precursor) together. The milling preferably occurs for an amount of time between about 1 to about 20 hours, and preferably for about two hours or less. The milling conditions, such as the amount of time the adhesive precursor is milled, can vary depending upon the materials used in the coating and the desired properties of the adhesive 112.

After preparation, the adhesive precursor/conductive particle mixture is then applied to the contact regions 100 of the surface 90 of the first conductive sheet 58 that will be coupled with the other surface 92 of the opposite conductive sheet 60. To ensure good adherence of the adhesive 112 in accordance with the present invention, with certain conductive sheet compositions (e.g., metals) it is preferred that the surface 90, 92 of the conductive sheet 58, 60 is cleaned (e.g., by abrading and/or chemically etching) to remove all surface oxides and other contaminants from the regions where adhesive matrix 112 is to be used. Thus, in the cases of a conductive sheet 58, 60 fabricated from a metal, the surface 90, 92 can be chemically cleaned by (1) degreasing with methyl-ethyl-ketone, and (2) pickling for 2 to 5 minutes in a solution comprising (a) 40% nitric acid, (b) 2% to 5% hydrofluoric acid, (c) 4 grams/gallon of ammonium biflouride, and water. Alternatively, the surfaces 90,92 of the conductive sheets 58,60 may be physically cleaned by abrading the surfaces with 100 to 220 grit abrasive followed by cleaning and degreasing with acetone, or by cathodically cleaning the substrate in the presence of a metal cleaning electrolyte.

In the embodiment shown in FIG. 4, conductive adhesive 112 is applied to both the first coolant side contact surface 90 of the first sheet 58 and the second coolant side contact surface 92 of the second sheet 60, thus both of these surfaces 90,92 are cleaned prior to application of the adhesive 112. The adhesive 112 may be used to coat the entire surfaces 90, 92 of the conductive sheet 58, 60 to provide corrosion protection therefore, or in alternate embodiments, may be applied to discrete regions (i.e. contact regions 100) that are electrical and physical contact points.

The conductive adhesive 112 pre-cursor may be brushed, dabbed, laminated (such as by hot rolling), sprayed, spread (such as with a doctor blade), coil or roll coated, screen printed, silk screened or rolled onto the surface of the sheets 58, 60, but it is preferred that the precursor of the adhesive 112 is applied to confined sites 100 where contact between the sheets is to occur. In certain preferred embodiments, the precursor to the adhesive 112 is applied to both the first contact surface 90 of the first sheet 58 and to the second contact surface 92 of the second sheet 62. In an alternate embodiment, the adhesive 112 may be applied to only one surface 90 or 92 of either of the sheets 58, 60. In preferred embodiments, a mask is first applied over the sheets 58, 60. The mask has openings therein which are situated over the contact regions 100, or sites where gluing or adherence is to occur. The adhesive 112 precursor is then applied through the openings in the mask. The adhesive 112 precursor is preferably applied to a thickness of about 0.001 to about 0.002 inches. The sheets 58,60 are sandwiched together in a suitable fixture that applies uniform pressure across the sheets 58,60.

In various embodiments, the adhesive 112 precursor, preferably comprising an epoxy adhesive resin, may be cured after being applied to form the polymer of the adhesive 112. According to the certain preferred embodiments of the present invention, the precursor resin of the adhesive matrix is cured to impart a structural cohesiveness to the adhesive 112 itself. The curing prevents the adhesive 112 from being eroded or washed away by the coolant circulating in the coolant flow channels 93. Thus, in certain embodiments, curing occurs by heating the sandwiched sheets 58,60 in a hot press with pressure application to cure the polymer adhesive matrix material to form the assembly.

The adhesive 112 must be selected such that it is capable of withstanding the high electrical potentials and exposure to coolant flowing within the coolant flow channels that will be formed by the coupling of the first sheet 58 to the second sheet 60. Further, a preferred adhesive polymer for the matrix of the adhesive 112 according to the present invention has the requisite tackiness to adhere and couple the first and second conductive sheets 58, 60 to one another for long periods withstanding the fuel cell operating conditions. According to various embodiments of the present invention, the adhesive 112 overlaying the contact surface 90, 92 of the conductive sheet 58, 60 comprises an epoxy adhesive, which has been found to be particularly durable, robust, and well-suited to the harsh fuel cell environment.

Preferably, such an epoxy adhesive is formed by precursor materials that are a two-component system that can be cured to achieve cross-linking of the polymer resin within the matrix. Generally, a first part of the two-component system is the epoxy resin and a second part is the epoxy curing agent. Epoxy resins are well-known, and include, for example, the diglycidyl ether of bisphenol A (also known as DGEBA), and resins formed by condensation of DGEBA with bisphenol A. Other epoxy resins include the dicylcidyl ether of bisphenol F (also known as DGEBF) and its oligomers formed by condensation with bisphenol F. The curing agents can comprise any number of epoxy curing agents known in the art, and preferably are selected from linear aliphatic amines and cycloaliphatic amines. Examples of suitable linear aliphatic amines include diethylene triamine (DETA), triethylenetetramine (TETA) and tetraethylene pentamine (TEPA). Likewise, examples of cycloaliphatic amines include isophorone diamine (IPDA), N-aminoethylpiperazine (AEP), p-aminocyclohexyl methane (PACM-20), and 1,2-diaminocyclohexane.

In certain embodiments, the crosslinking entails curing after applying the adhesive and contacting and assembling the sheets 58, 60 together. In certain preferred embodiments, the curing is conducted at temperatures from ambient to about 100° C., more preferably between ambient and 90° C., and in certain embodiments, preferably less than 70° C. In certain preferred embodiments, low heat application (i.e., 60-90° C.) can be used to facilitate the curing of the matrix of the adhesive 112. After contacting the precursor of the adhesive 112 in the appropriate pre-selected contact regions 100, heat, and optionally pressure, is applied to cure the polymeric matrix resin in the adhesive 112 to a fully cured level. The plates 58, 60 having adhesive 112 precursor disposed therebetween are cured for about 3 minutes to about 30 minutes, and more preferably, for about 5 minutes.

The adhesive 112, like the sheets themselves, is substantially insoluble in the coolant flowing between the sheets 58 and 60 in that the conductive particles therein will not dissolve and contribute metallic ions to the coolant which causes the otherwise substantially dielectric (i.e., resistivity greater than about 200,000 Ohm-cm) coolant to become inordinately conductive. If the coolant becomes conductive, stray currents flow through the stack via the coolant and short circuiting, galvanic corrosion and coolant electrolysis can occur. Conductive particles are considered to be substantially insoluble if their solubility in the coolant, over time, does not cause the coolant's resistivity to drop below about 200,000 Ohm-cm. Hence when water is used as the coolant metals such as copper, aluminum, tin, zinc and lead are to be avoided, or completely encapsulated in the adhesive matrix 112. In certain preferred embodiments, the adhesive matrix 112 will be highly resistant to hydrogen and mild acids (HF at pH of between 3 to 4), and inert to (i.e., release no ions) solvents such as deionized water, ethylene glycol and methanol at 100° C. Thus, the selection of the conductive particles and the adhesive polymer 112 is dependent on the compatibility with the coolant used within the fuel cell.

Bondline durability translates to a bond at the one or more contact regions 100 that endures many hours of fuel cell operation and temperature fluctuations, without degrading or increasing contact resistance to an impermissible level. The use of an epoxy adhesive 112 according to the present invention prolongs the longevity of the fuel, cell system, and maintains operational efficiency. As described above, adhesives that comprise epoxy are particularly preferred.

The present invention will be further explained by way of the example. It is to be appreciated that the present invention is not limited by the example.

### EXAMPLE 1

A mixture of acetylene black and expanded graphite are added together at a ratio of 1:2 by weight, and mixed thoroughly to create a homogenous mixture of both materials. In a separate container, a two-component epoxy resin is mixed with a curing agent (i.e., a hardener) to prepare the epoxy adhesive. The conductive adhesive matrix is prepared by adding the epoxy to the expanded graphite/carbon mixture using a ratio of 9:1 (epoxy: total carbon by weight). The conductive adhesive matrix is mixed thoroughly to make a homogenous mixture of the carbon in the epoxy. Two composite plates are molded from a commercial conductive molding compound (commercially available from Bulk Molding Compound, Inc. “BMCI” of West Chicago, Ill.) formed of polyvinyl ester and graphite. The plates have a thickness of about 0.5 mm with pre-molded flow fields of lands and grooves. The plates are coated by brushing with the conductive epoxy adhesive of the present invention on the contact regions or lands. The two plates are bonded together and the adhesive is cured at 90° C. for 5 minutes under an applied compressive pressure of 300 psi.

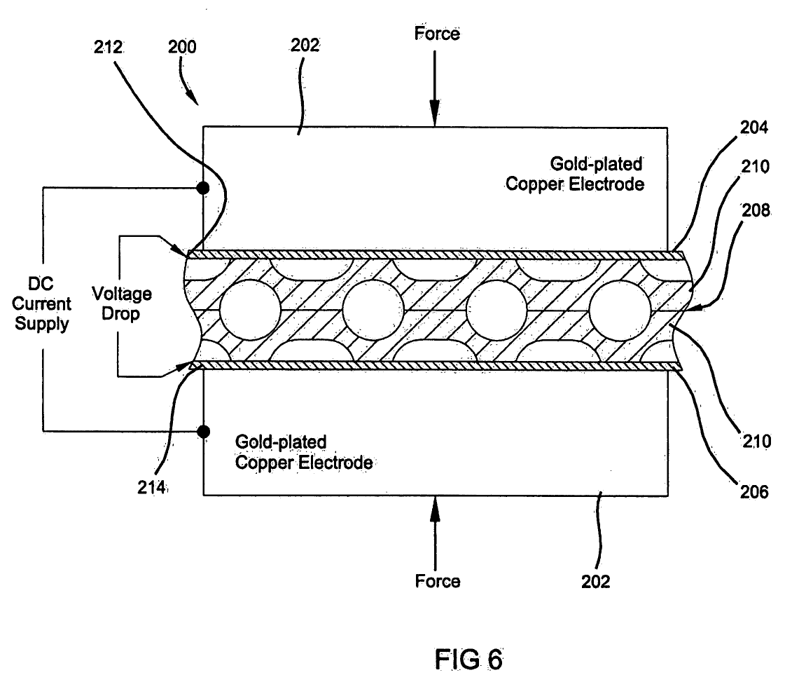

The samples are tested in an apparatus as shown in FIG. 6. The bondline resistance measurements of the electrically conductive element assembly comprising conductive sheets that sandwich adhesive between surfaces are measured as shown in FIG. 6. The testing apparatus comprises a carver press 200 with gold coated platens 202 and a first and second electrically conductive activated carbon paper media 204,206 respectively, pressed between a sample 208 and the gold coated platens 202. A surface area of 6.45 cm² was tested using 1 A/cm² current which is applied by a direct current supply. The resistance is measured using a four-point method and calculated from measured voltage drops and from known applied currents and sample 208 dimensions. For metallic samples of negligible bulk resistance, the voltage drop is measured across the adhesive bondline on the sample surface 210, 210 (contact resistance plus bulk adhesive resistance). As shown in FIG. 6, the sample 208 preferably comprises the electrically conductive element (e.g., bipolar plate) having two sheets 210 coupled together.

Bondline resistance measurements were measured as contact resistance (mOhm.cm² from paper to paper) with incremental force applied at the following pressures: 25 psi (about 175 kPa), 50 psi (about 350 kPa), 75 psi (about 525 kPa), 100 psi (about 675 kPa), 150 p.s.i (about 1025 kPa), 200 psi (about 1400 kPa), and 300 psi (about 2075 kPa). As appreciated by one of skill in the art, the measurements provided here are of contact resistance across the entire assembly of the separator plate, and are greater than those across the bondline alone, and thus the values reflect higher resistance across the entire assembly.

It should be noted that the contact resistance of the conductive carbon paper 204,206 is generally a known value, which can be subtracted from the measurement to establish the contact resistance of the metal plate 210 only. During testing of the samples, a 1 mm thick Toray carbon paper (commercially available from Toray as TGP-H-0.1T) was used for the first and second carbon paper media 204,206. However, in many circumstances the contact resistance of the conductive paper 204,206 is negligible and adds such a small incremental value to the contact resistance value, that it need not be subtracted. The values referred to herein are the bulk contact resistance across the sample 208. In TABLE 1, Sample 1 is an electrically conductive element prepared according to the present invention as described in Example 1. Control 1 is a composite bipolar plate that is not bonded together, but merely pressed together at the contact regions. Control 2 has two composites glued by conventional means, namely a conventional electrically conductive adhesive available from BMCI having from about 40 to about 75% unsaturated vinyl ester and from about 10 to about 30% styrene, with graphite from about 25 to about 50%.

TABLE 1

| Applied | | Total Resistance (mOhm · cm²-paper to paper) | | |
|---|---|---|---|---|
| Pressure | | Control 1 | Control 2 | Sample 1 |
| 25 | psi | 56 | 39 | 39 |
| (˜175 | kPa) | | | |
| 50 | psi | 37.5 | 27 | 27 |
| (˜350 | kPa) | | | |
| 75 | psi | 29.8 | 23 | 21.5 |
| (˜525 | kPa) | | | |
| 100 | psi | 25.5 | 20.5 | 19.5 |
| (˜675 | kPa) | | | |
| 150 | psi | 21.1 | 17.9 | 16.5 |
| (˜1025 | kPa) | | | |
| 200 | psi | 17 | 17.1 | 16.2 |
| (˜1400 | kPa) | | | |
| 300 | psi | 14.6 | 16 | 14.1 |
| (˜2075 | kPa) | | | |

As can be observed in Table 1, Sample 1 shows that bonded plates using the adhesive matrix of the present invention have fairly comparable resistance to Control 1, which shows that the adhesive did not introduce any additional resistance through the bondline, as where Control 2 with the conventional adhesive generally had a comparable or higher resistance than Sample 1. A fuel cell typically operates at compression loads of about 200 psi to about 400 psi (˜1400-2750 kPa), thus the bondline resistance is lower for Sample 1 than for Control 2 from 200 to 300 psi (˜1400-2075 kPa) of applied pressure, which simulates fuel cell operating conditions.

An electrically conductive element for use in a fuel cell prepared according to the various embodiments of the present invention demonstrates an improved bond having greater adhesion and long term durability in a fuel cell environment. Moreover, the electrically conductive fluid distribution plate according to the present invention provides low long-term contact resistance across the regions of contact along the bond increasing the operational efficiency of the fuel cell stack and further permits the use of lower compression pressures to increase fuel cell stack life. The durable and robust bond in the bipolar plates seals the coolant flow channels and prevents any potential leakage or shunt current damage via adhesive leaching or degradation. Likewise, the improved bond of the present invention reduces the inefficiency of the fuel cell stack operation, by reducing the attenuated consumption of generated energy by thermal and electrical losses across the bondline.

While the invention has been described in the terms of specific embodiments thereof, it is not intended to be limited thereto but rather only to the extent set forth hereafter in the claims which follow. The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A conductive element for a fuel cell comprising;
a first conductive sheet having a first surface;
a second conductive sheet having a second surface, wherein said first surface confronts said second surface;
a conductive adhesive disposed between and in contact with said first surface and said second surface at one or more contact regions creating a durable bond between said first and second surfaces, wherein said bond has an electrical resistance of less than or equal to about 5 mΩ.cm² under a compressive force of greater than or equal to about 1000 kPa, wherein said conductive adhesive is formed from an epoxy and comprises a plurality of conductive particles comprising graphite and carbon black.

2. The element of claim 1 wherein a ratio of said graphite to said carbon black is from about 1:6 to about 35:1 by weight.

3. The element of claim 1 wherein said conductive adhesive comprises less than or equal to about 20% by weight of said conductive particles.

4. The element of claim 1 wherein said bond resistance is less than or equal to about 4 mOhms.cm² under a compressive force of greater than about 1400 kPa after exposure to fuel cell operating conditions in excess of 500 hours.

5. The element of claim 1 wherein said bond resistance is less than or equal to about 1 mOhms.cm² under a compressive force of greater than or equal to about 1400 kPa after exposure to fuel cell operating conditions in excess of 500 hours

6. The element of claim 1 wherein said first and said second conductive sheets comprise an electrically conductive metal.

7. The element of claim 1 wherein said first and said second conductive sheets comprise an electrically conductive polymeric composite.

8. The element of claim 1 wherein said graphite is selected from one or more of: expanded graphite, graphite powder, graphite flakes, and mixtures thereof.

9. The element of claim 1 wherein said graphite is expanded graphite.

10. The element of claim 1 wherein said conductive adhesive is formed from a cured two component epoxy adhesive system.

11. The element of claim 10 wherein said two component epoxy adhesive system comprises the reaction product of an epoxy resin and an amine curing agent, wherein said epoxy resin comprises a diglycidal ether of bisphenol A.

12. The element of claim 1 wherein said first and said second surfaces are joined to one another at said one or more contact regions by said adhesive which forms a fluid-tight seal.

13. A method of forming a durable electrical conductive contact element for a PEM fuel cell, said method comprising:
mixing a two-component epoxy adhesive system with a plurality of conductive particles comprising graphite and carbon black;
applying said two-component epoxy adhesive system to at least one of: a first conductive sheet of the element having a first surface and a second conductive sheet of the element having a second surface;
contacting said first surface with said second surface, wherein said adhesive system is disposed between and in contact with said first surface and said second surface at one or more contact regions; and
curing said adhesive polymer system to create an electrically conductive durable bond at said one or more contact regions between said first and second surfaces.

14. The method of claim 13 wherein said curing comprises application of at least one of: heat and pressure.

15. The method of claim 13 wherein said bond has an electrical resistance of less than or equal to about 5 mΩ.cm² under a compressive force of greater than or equal to about 1000 kPa after exposure to fuel cell operating conditions in excess of 500 hours.

16. The method of claim 13 wherein a ratio of said graphite to said carbon black is from about 1:6 to about 35:1 by weight.

17. The method of claim 13 wherein said two component epoxy adhesive system comprises an epoxy resin and an amine curing agent, wherein said epoxy resin comprises a diglycidal ether of bisphenol A.

18. A fuel cell stack comprising a plurality of fuel cells and an electrically conductive element sandwiched between an anode and cathode of adjacent fuel cells comprising:
a first electrically conductive sheet having an anode confronting surface and a first heat exchange surface;
a second electrically conductive sheet having a cathode confronting surface and a second heat exchange surface;
wherein said first and second heat exchange surfaces confront each other so as to define therebetween a coolant flow passage adapted to receive a liquid coolant and being electrically coupled to one another at a plurality of contact sites via an electrically conductive adhesive comprising a plurality of conductive particles dispersed in an epoxy polymer having adhesive properties, wherein said electrically conductive adhesive defines an electrically conductive path between said first and second sheets.

19. The stack of claim 18 wherein an electrical resistance across said electrically conductive path is sufficiently low such that current generated by the anode and cathode is conducted therefrom at a rate sufficient to prevent overheating of said coolant.

20. The stack of claim 19 wherein said adhesive forms a fluid-tight seal.
